(19) United States
(12) Patent Application Publication
(10) Pub. No.: US 2016/0000159 A1
(43) Pub. Date: Jan. 7, 2016

(54) HYPOALLERGENIC EXERCISE GARMENT AND MATERIAL

(71) Applicant: Rob Falken, Oceanside, CA (US)

(72) Inventor: Rob Falken, Oceanside, CA (US)

(21) Appl. No.: 14/324,241

(22) Filed: Jul. 7, 2014

(51) Int. Cl. A41D 27/02; B32B 5/02; B32B 5/24

(52) U.S. Cl. CPC A41D 27/02; B32B 5/245; B32B 5/024; B32B 2262/0269; B32B 2266/08; B32B 2307/72; B32B 2437/00; B32B 2307/51; B32B 2262/0253

(57) ABSTRACT

A hypoallergenic exercise garment and material is described consisting of a class of copolymers or a physical mix of polymers consisting of materials with both thermoplastic and elastomeric properties to produce thermoplastic resin pellets. The non-toxic thermoplastic resin pellets are mixed with additives and a blowing agent to produce thermoplastic elastomer closed-cell foam for use in exercise garments. Depending on the exercise garment application, the density of the thermoplastic elastomer foam may vary. In many exercise garment applications low densities such as less than 0.22 grams per cubic centimeters are desirable.

### BACKGROUND

This disclosure relates generally to hypoallergenic materials having qualities for use in exercise garments and other products. In particular, this document describes thermoplastic elastomer closed-cell foam material.

Many people find it hard to reduce and/or maintain their body weight. Obesity has been on the rise globally due at least in part to high-calorie diets and lack of exercise, which consequently causes a variety of diseases. One of the most effective and popular means of loosing weight is the act of perspiration (also known as sweating) either through exercise or other available methods. In order for a person to break a sweat, a person must exercise vigorously. Many types of conventional exercise garments exist in the art that claim to help wearers increase perspiration with the least amount of effort possible. Trapping air and moisture and preventing it from escaping achieve this. However, such kinds of conventional exercise garments are commonly made from neoprene, which is a known allergen and relatively toxic for the environment.

The present invention is directed to an exercise garment made from the hypoallergenic material in accordance with implementations described herein. Such an exercise garment provides the wearer with the beneficial effects particularly suitable for assisting weight loss. The portion of the exercise garment that incorporates the hypoallergenic material described herein will dictate the properties of the final exercise garment. The exercise garment could be formed completely of the hypoallergenic material described herein, thereby increasing the heating effect of the exercise garment. Alternatively, the exercise garment may be only partially formed of the hypoallergenic material described herein, allowing the quantum of the beneficial effects provided by the hypoallergenic material to be varied as desired. In particular, exercise garments with partially formed hypoallergenic material enable targeted heating of particular body parts.

The beneficial effects of the exercise garment are heightened during exercise. Therefore, in certain embodiments, the exercise garment of the present invention is suitable for wearing during a form of exercise. The exercise garment also offers beneficial effects when worn immediately after exercise during recovery. Therefore, the exercise garment may be worn during exercise and immediately thereafter.

Conventional exercise garments commonly use neoprene, also known as polychloroprene, a product of synthetic rubber, to increase perspiration and heating. Unfortunately, neoprene has several major disadvantages. These include rubber allergy, high toxicity, and a high carbon footprint, among others. With regard to rubber allergy, 15% of the world's population is allergic to neoprene. The American Contact Dermatitis Society labeled neoprene rubber as a common source of mixed dialkyl thioureas, and in 2009 labeled neoprene as “Allergen of the Year” as being a primary source of allergic contact dermatitis. As for neoprene's toxicity, the material contains heavy metals, formaldehyde, phthalates, lead, and chlorine, which are all known to be harmful to humans. With regard to neoprene's carbon footprint, the material resists decomposition until temperature extremes of approximately 800 degrees Celsius, at which point it converts into carbon and omits toxic gas. Unfortunately, landfills and environmental decomposition conditions don't reach the temperature requirements to adequately decompose neoprene. This effectively means that neoprene will effectively not degrade over time. The process of decomposition is essential for recycling finite matter that occupies the physical space of this planet.

Thus, there exists a clear need for an exercise garment material that is not based on neoprene, does not have the allergen potential or the levels of toxicity of neoprene, and which has a lower carbon footprint in manufacturing and is more readily decomposable than neoprene and conventional materials suitable for such applications as exercise garments or the like.

### SUMMARY

This document describes a hypoallergenic material for use in an exercise garment and other products. In some aspects, the hypoallergenic material is formed of thermoplastic elastomer closed-cell foam material having a low density. In some instances, the density of the closed-cell foam material can be less than 0.22 grams per cubic centimeter.

In some aspects, the thermoplastic elastomer material is based on a hypoallergenic thermoplastic elastomer closed-cell foam. The thermoplastic elastomer material described herein insulates as well or better than neoprene. As used as an exercise garment material, the thermoplastic elastomer material can withstand tearing, rough handling and severe conditions, yet is inherently flexible. Furthermore, the thermoplastic elastomer material is inert to most chemical agents, and is free of heavy metals, formaldehyde, phthalates, lead, and chlorine, or other toxic agents or compounds.

In one aspect, an exercise garment is disclosed. The exercise garment includes one or more sheets of closed-cell foam formed to cover one or more body parts of a wearer. The closed-cell foam is derived from thermoplastic elastomer mixed with at least one foaming agent, and being formed to a density of less than 0.22 grams per cubic centimeter, each of the one or more sheets of closed-cell foam having a thickness between 0.5 millimeters and about 2.5 millimeters, and more particularly in the range of 1 millimeter to 1.5 millimeters, enabling movement of the one or more body parts of the wearer when covered by the one or more sheets of closed-cell foam.

In another aspect, a method for manufacturing an exercise garment is disclosed. The method includes providing one or more sheets of closed-cell foam formed to cover one or more body parts of a wearer. As described above, the closed-cell foam is derived from thermoplastic elastomer mixed with at least one foaming agent. The closed-cell foam is formed to a density of less than 0.22 grams per cubic centimeter. Each of the one or more sheets of closed-cell foam have a thickness between about 0.5 millimeter and about 2.5 millimeters, and more particularly in the range of 1 millimeter to 1.5 millimeters, enabling movement of the one or more body parts of the wearer when covered by the one or more sheets of closed-cell foam. The method further includes assembling the one or more sheets of closed-cell foam into a pattern defining at least a portion of the exercise garment.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a cross section of the thermoplastic elastomer closed-cell foam;

FIG. 2 is a cross section of the thermoplastic elastomer closed-cell foam with a fabric covering;

FIG. 3 is a cross section of the thermoplastic elastomer closed-cell foam with an inner liner;

FIG. 4 is a cross section of the thermoplastic elastomer closed-cell foam with a fabric covering and an inner liner; and

FIG. 5 illustrates a pair of shorts using thermoplastic elastomer closed-cell foam.

FIG. 6 illustrates a pair of leggings using thermoplastic elastomer closed-cell foam.

FIG. 7 illustrates a pair of capri leggings using thermoplastic elastomer closed-cell foam.

FIG. 8 illustrates a vest using thermoplastic elastomer closed-cell foam.

FIG. 9 illustrates a long-sleeved top using thermoplastic elastomer closed-cell foam.

FIG. 10 illustrates a hooded long-sleeved top using thermoplastic elastomer closed-cell foam.

Like reference symbols in the various drawings indicate like elements.

### DETAILED DESCRIPTION

This document describes a hypoallergenic material for use in an exercise garment and other products. The hypoallergenic material can include, without limitation, a hypoallergenic thermoplastic elastomer foam, which can be formed to insulate as well as, or better than, neoprene (also known as polychloroprene). Further, thermoplastic elastomer foams as described herein withstand tearing, rough handling and severe conditions, are inherently flexible, and can be formed to a desired flexibility and pliability. Thermoplastic elastomer foams are inert to most chemical agents, and are free of formaldehyde, phthalates, lead, chlorine, or other toxic agents or compounds.

In some implementations, the hypoallergenic material is formed at least in part of thermoplastic elastomer foam (TPE foam), and in specific implementations, can be based on a hypoallergenic thermoplastic elastomer closed-cell foam, as described in further detail below. Thermoplastic elastomer closed-cell foam is a low modulus, flexible material that can be stretched repeatedly, which is an ideal characteristic for the production of material for exercise garments.

Thermoplastic elastomers (TPEs) are a group of polymers that exhibit instantaneous reversible deformation (to be an elastomer). Most TPEs consist of a continuous phase that exhibit elastic behavior and a dispersed phase that represents the physical crosslinks. If the dispersed phase is elastic, then the polymer is a toughened thermoplastic, not an elastomer. Elastomer reversibility must have physical cross-links, therefore these crosslinks must be reversible. Physical crosslinks do not exist permanently and may disappear with the increase of temperature.

TPE foam is made up of a class of copolymers or a physical mix of polymers consisting of materials with both thermoplastic and elastomeric properties. Generally, thermoplastic elastomers can be categorized into two groups: multi-block copolymers and blends. The first group is copolymers consist of soft elastomers and hard thermoplastic blocks, such as styrenic block copolymers (SBCs), polyamide/elastomer block copolymers (COPAs), polyether ester/elastomer block copolymers (COPEs) and polyurethane/elastomer block copolymers (TPUs). TPE blends can be divided into polyolefin blends (TPOs) and dynamically vulcanized blends (TPVs).

In some implementations, as used herein, thermoplastic elastomers are two-phase systems consisting of a rubbery elastomeric (soft phase) component and a rigid (hard phase) component. The soft phase can include polybutadiene, poly(ethylene-co-alkene), polyisobutylene, poly(oxyethylene), poly(ester), polysiloxane or any other elastomers, while the hard phase can include polystyrene, poly(methyl methacrylate), urethane, ionomer-poly(ethylene-co-acrylic acid) (sodium, Mg, Zn salt), ethylene propylene diene monomer, and fluropolymers.

Thermoplastic elastomers must be two-phase materials, and each molecule must consist of two opposite types of structure, one the elastomeric part and the second the restraining, physical cross-linking part. Thermoplastic elastomers are typically block copolymers. The elastic block should have high molar mass and possess all of the others characteristic required of an elastomer. The restraining block should resist viscous flow and creep. One restraining block can be used per macromolecule, giving a diblock copolymer (AB), or one restraint block at each of the elastomer can be used giving a triblock copolymer (ABA). To provide an example of thermoplastic elastomer block copolymer structures the monomers butadiene and styrene are chosen.

TPE closed-cell foam that is suitable for the presently described implementations includes a thermoplastic elastomer (thermoplastic polymer resin) compound, sometimes referred to as thermoplastic rubber. In some implementations, the thermoplastic elastomer (thermoplastic polymer resin) compound is made up of a class of copolymers or a physical mix of polymers that includes materials with both thermoplastic and elastomeric properties. The TPE foam used herein can have a thermoplastic elastomer (thermoplastic polymer resin) content of between 40% and 60%, but can also have an thermoplastic elastomer (thermoplastic polymer resin) content of less than 40% and greater than 60%. In particular implementations, the TPE foam is formed with a foaming agent, and includes additives, and/or fillers. For example, a suitable foaming agent can be a chemical foaming and nucleating agent such as Hydrocerol® marketed by Clariant Corporation. Additives can include pigments, dyes, or thermal enhancement compounds. Fillers can include, for example, calcium carbonate to improve cell structure of the closed cell foam. Other foaming agents, additives, and/or suitable fillers can be used.

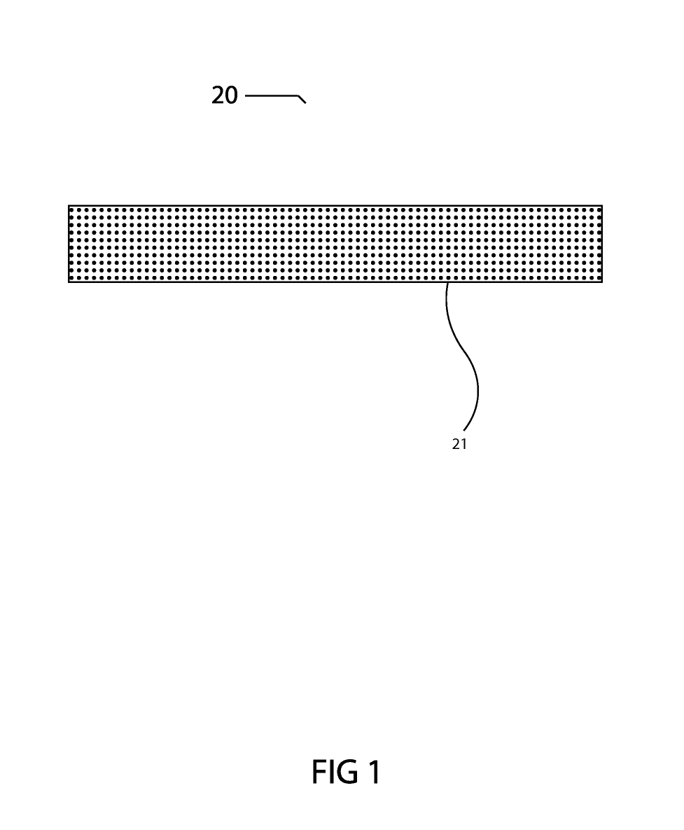

FIG. 1 illustrates a cross-section of an elastomer material 20 that is hypoallergenic, for use in exercise garments and other products. In some implementations, the elastomer material 20 is made from thermoplastic elastomer closed-cell foam, 21. The thickness of the elastomer material 20 may vary, depending on a specific application, such as where the exercise garment is used, for how long, etc. In some implementations, the thickness of the elastomer material 20 is sufficient to allow movement by the wearer, yet thermally insulative to increase heat and perspiration. Accordingly, the elastomer material 20 can have thicknesses of substantially half a millimeter, one and a half millimeters, two and a half millimeters, or more. In other implementations, the elastomer material 20 can have a thickness of less than half a millimeter. Thermoplastic elastomer closed-cell foam may be produced in various colors to further enhance the desirability of an exercise garment formed of the elastomer material 20.

A method of producing a thermoplastic elastomer closed-cell foam includes providing a foamable thermoplastic elastomer (thermoplastic polymer resin), such as Thermolast® by KRAIBURG TPE GmbH & Co. KG, having a suitable hardness value to permit production of soft, low-density foam. The provided foam preferably exhibits compressibility (i.e. load bearing) characteristics that allow the foam to deform easily, yet still resist permanent deformation (compression set) when the load is removed. Other suitable thermoplastic elastomers (thermoplastic polymer resins) can be used.

In accordance with one method consistent with implementations described herein, a thermoplastic elastomer closed-cell foam formed by incorporating polymerized thermoplastic resin compound pellets into a melted mixture with foaming agents, black carbon pigments, or, alternatively, other colored pigments, fillers, plasticizers, and other desired additives. The mixture of polymerized thermoplastic resin compound pellets, foaming agents, and other fillers are then baked in an oven to expand the mixture into a foam block. Once baked, the foam block is cooled, leaving a large closed-cell foam sponge block of approximately 150 mm thick with a very high independent closed-cell structure. As soon as the sponge block is cured, it is then sliced horizontally into foam sheets of a desired thickness.

In alternative implementations, a thermoplastic elastomer closed-cell foam is produced by feeding polymerized thermoplastic resin compound pellets into an extruder, and through the shearing action of one or more screws, melting the compound continuously in the barrel of the extruder. In an intermediate or a mixing section, a blowing agent, usually in a liquid or gaseous state, is continuously injected into the molten compound. In some instances, a chemical blowing agent can dispersed throughout the particulate compound in a powder form before the material is fed to the extruder. In either case, the extruder screw can be designed to mix and dissolve the blowing agent as uniformly as possible in the molten compound. Thorough, uniform mixing is essential to the production of high quality foam. The resultant mixture is maintained under carefully controlled temperatures and pressures within the extruder in order to prevent the volatilization of the blowing agent.

The molten mixture is then forced through a die, and the material undergoes decompression to atmospheric pressure so that the blowing agent separates within the body of material as it bubbles. If the temperature is too high, there is overexpansion and the cells rupture. If the temperature is too low, there is incomplete expansion, resulting in low quality foam. In many instances, the temperature window between overexpansion and underexpansion is only a few degrees Fahrenheit.

The thermoplastic elastomer closed-cell foam may contain additives, if necessary for a certain application of an exercise garment formed thereof. The additives can be provided in an amount by which the mechanical strength and the flexibility are not affected adversely, and can include an antistatic agent, weatherability-imparting agent, UV absorber, glidant, antibacterial agent, antifungal agent, far infrared ray (FIR) agent, negative ion agent, phase change material, tackifier, softener, plasticizer, filler such as titanium oxide, carbon black, dry silica, wet silica, aramid fiber, mica, calcium carbonate, potassium titanate whisker, talc, barium sulfate, and the like.

Various densities of thermoplastic elastomer foam that has been expanded into a closed-cell structure may be used to make an exercise garment of the material described herein. Low densities, for example, less than about 0.22 grams per cubic centimeter are well suited for making the exercise garment. Other densities may also be used.

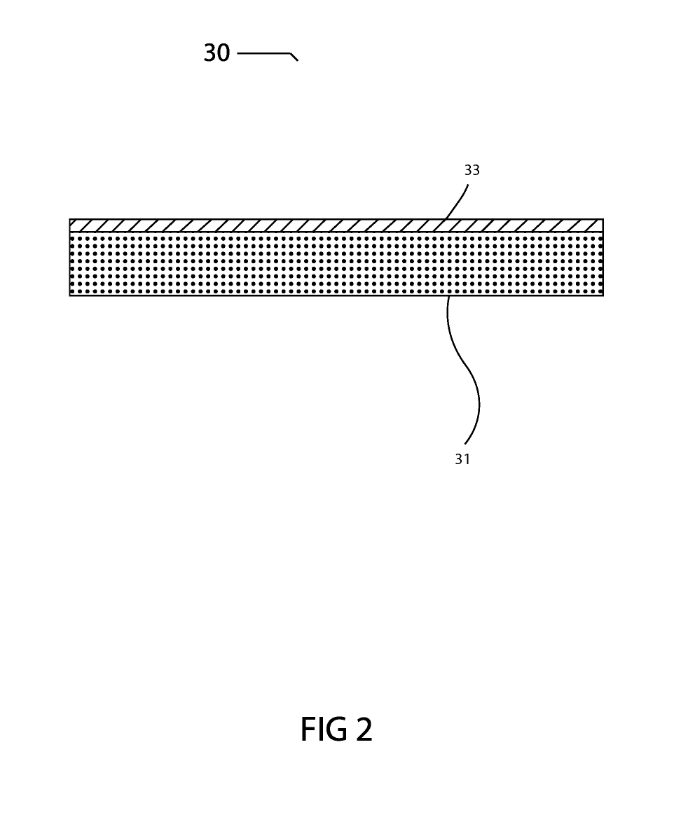

FIG. 2 illustrates a cross section of a thermoplastic elastomer closed-cell foam 31 having a fabric covering 33. The fabric covering 33 can be used to further strengthen and reinforce the thermoplastic elastomer closed-cell foam 31. In some implementations, the fabric covering 33 is bonded to the thermoplastic elastomer closed-cell foam 31 using an adhesive, a heat process, a cold process, or the like. The fabric covering 33 can be formed of a woven polypropylene, woven nylon, aramid fiber. Lycra, spandex, or the like.

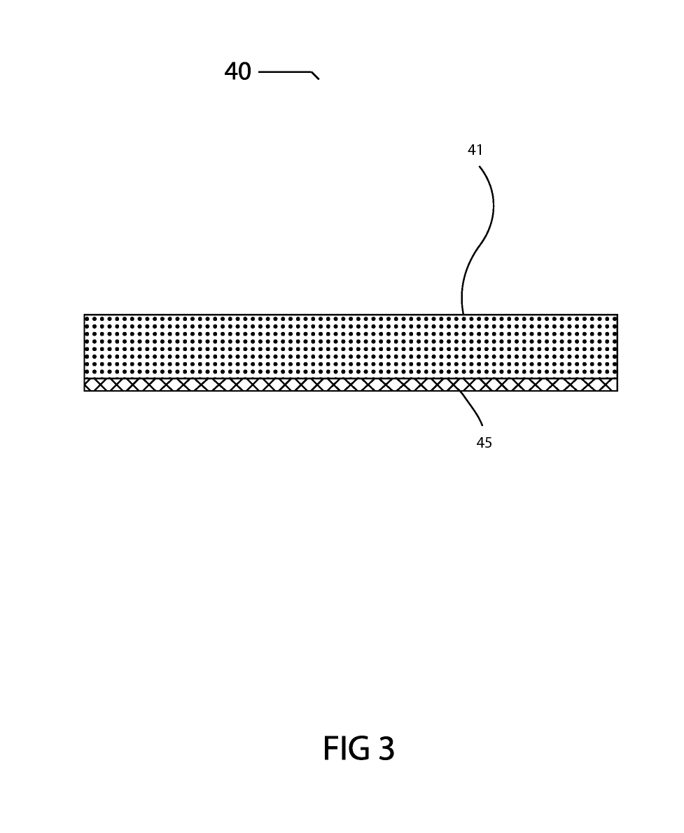

FIG. 3 illustrates a cross section of an exercise garment material 40 having a thermoplastic elastomer closed-cell foam 41 and an inner liner 45. The inner liner 45 can be used to provide added comfort to the user. In some implementations, the inner liner 45 is bonded to the thermoplastic elastomer closed-cell foam 41 using an adhesive, a heat process, a cold process, or the like. In some exemplary implementations, the inner liner 45 can include a spun nylon, jersey, or a low friction coating such as an SCS coating, Lycra, spandex, far infrared ray (FIR) agent, negative ion agent, phase change material, or the like.

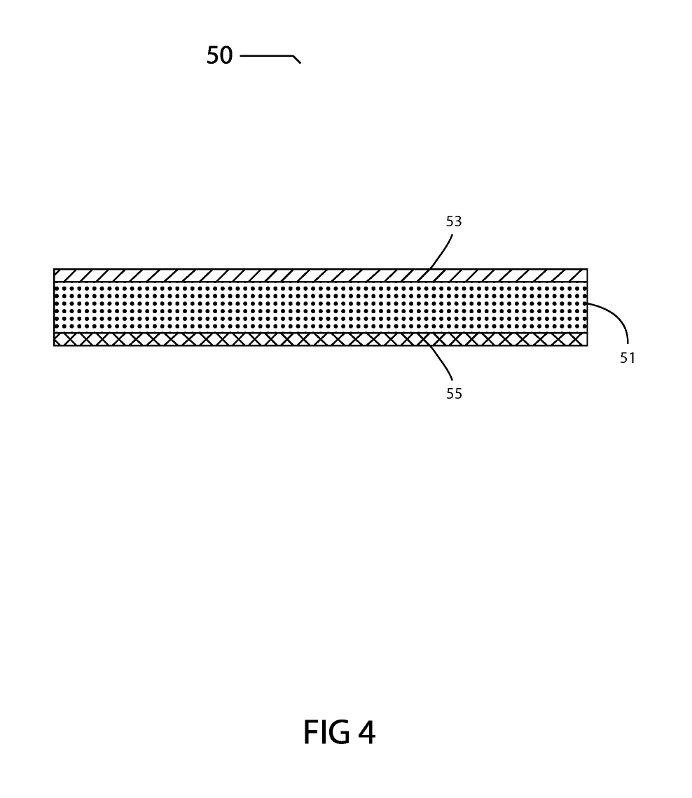

FIG. 4 illustrates a cross section of an exercise garment material 50 having an inner liner 55 and a fabric covering 53 applied to opposite sides of a thermoplastic elastomer closed-cell foam 51. The inner liner 55 can be bonded to the thermoplastic elastomer closed-cell foam 51 using an adhesive, a heat process, a cold process, or the like. Such inner liner can include a spun nylon, jersey, a low friction coating such as an SCS coating. Lycra, spandex, far infrared ray (FIR) agent, negative ion agent, phase change material, or the like. In a similar fashion, the fabric covering 53 can be bonded to the thermoplastic elastomer closed-cell foam 51 using an adhesive, a heat process, a cold process, or the like. The fabric covering 53 can include a woven polypropylene, woven nylon, aramid fiber, Lycra, spandex, or the like. In alternative implementations, other materials may be placed on either side of the thermoplastic elastomer closed-cell foam 51 to enhance performance, and/or to achieve desirable characteristics of the exercise garment material 50.

FIG. 5 depicts an exercise garment in the form of a pair of shorts 60 that provides partial leg coverage for the wearer, and that is hypoallergenic, in accordance with implementations described herein. The pair of shorts 60 can be formed of any style and size. The pair of shorts 60 can be formed of sheets of thermoplastic elastomer closed-cell foam, as described above, and constructed by automated machine cutting and seam bonding or hand cutting, tailoring and seam bonding. Automated or hand methods of assembly can be used to fabricated the sheets into the pair of shorts 60.

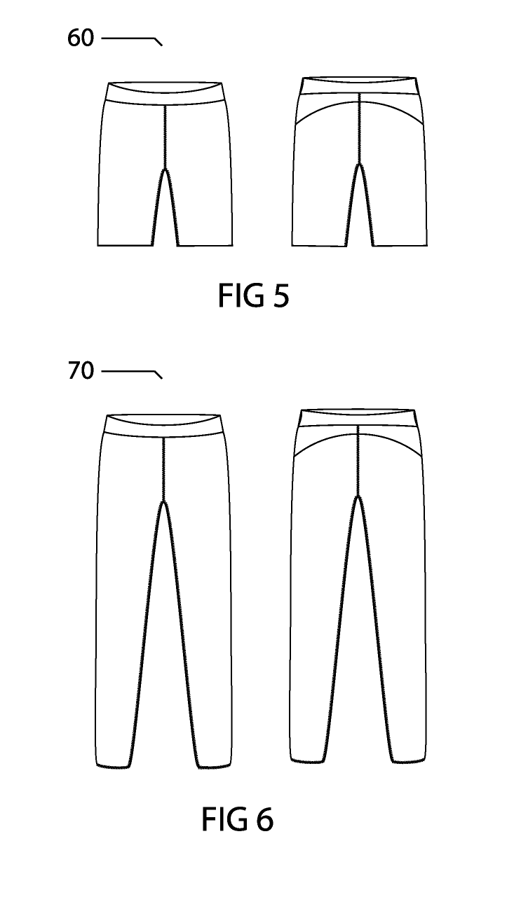

FIG. 6 depicts an exercise garment in the form of a pair of leggings 70 that provides full leg coverage for the wearer, and that is hypoallergenic, in accordance with implementations described herein. The pair of leggings 70 can be formed of any style and size. The pair of leggings 70 can be formed of sheets of thermoplastic elastomer closed-cell foam, as described above, and constructed by automated machine cutting and seam bonding or hand cutting, tailoring and seam bonding. Automated or hand methods of assembly can be used to fabricated the sheets into the pair of leggings 70.

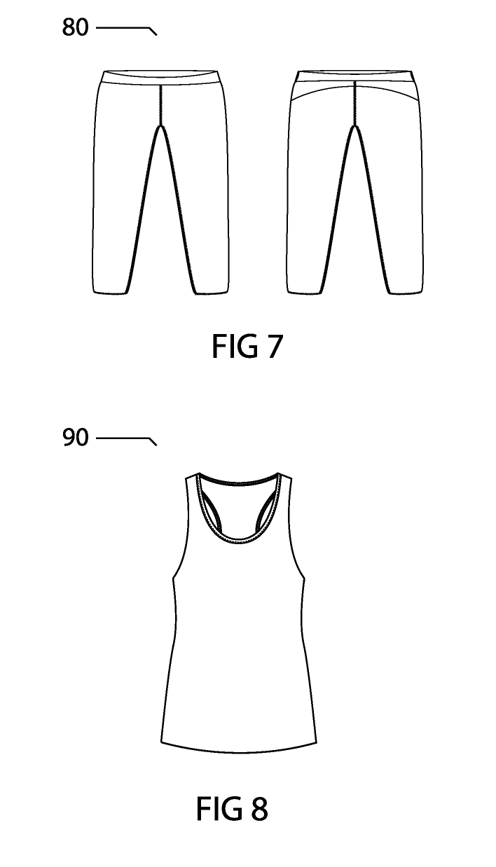

FIG. 7 depicts an exercise garment in the form of a pair of capri leggings 80 that provide leg coverage that is between that of the shorts 60 and that of the leggings 70, and that is hypoallergenic, in accordance with implementations described herein. The pair of capri leggings 80 can be formed of any style and size. The pair of capri leggings 80 can be formed of sheets of thermoplastic elastomer closed-cell foam, as described above, and constructed by automated machine cutting and seam bonding or hand cutting, tailoring and seam bonding. Automated or hand methods of assembly can be used to fabricated the sheets into the pair of capri leggings 80.

FIG. 8 depicts an exercise garment in the form of a vest 90 that provides coverage of the upper body excluding arms, and that is hypoallergenic, in accordance with implementations described herein. The vest 90 can be formed of any style and size. The vest 90 can be formed of sheets of thermoplastic elastomer closed-cell foam, as described above, and constructed by automated machine cutting and seam bonding or hand cutting, tailoring and seam bonding. Automated or hand methods of assembly can be used to fabricated the sheets into the vest 90.

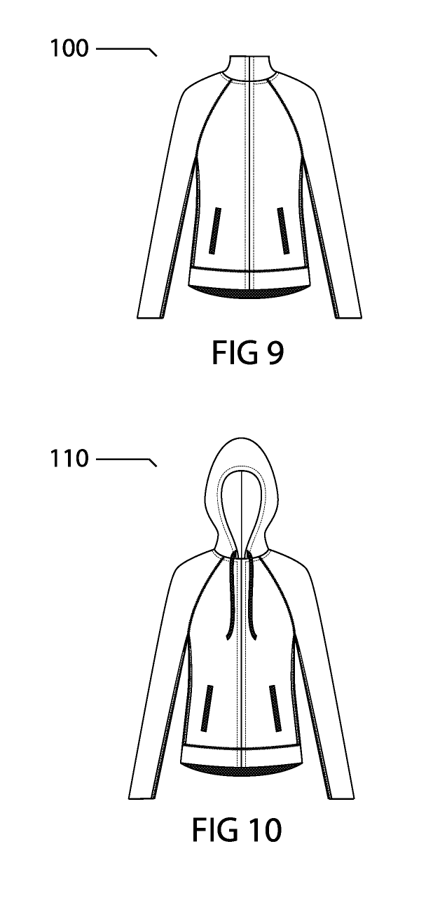

FIG. 9 depicts an exercise garment in the form of a long-sleeved top 100 that provides coverage of the upper body including arms, and that is hypoallergenic, in accordance with implementations described herein. The long-sleeved top 100 can be formed of any style and size. The long-sleeved top 100 can be formed of sheets of thermoplastic elastomer closed-cell foam, as described above, and constructed by automated machine cutting and seam bonding or hand cutting, tailoring and seam bonding. Automated or hand methods of assembly can be used to fabricated the sheets into the long-sleeved top 100.

FIG. 10 depicts an exercise garment in the form of a hooded long-sleeved top 110 that provides additional coverage for the head relative to the long sleeved top 100 depicted in FIG. 9, and that is hypoallergenic, in accordance with implementations described herein. The hooded long-sleeved top 110 can be formed of any style and size. The hooded long-sleeved top 110 can be formed of sheets of thermoplastic elastomer closed-cell foam, as described above, and constructed by automated machine cutting and seam bonding or hand cutting, tailoring and seam bonding. Automated or hand methods of assembly can be used to fabricated the sheets into the hooded long-sleeved top 110.

The range of garments allows various body parts to be covered by the hypoallergenic material described herein and so enables targeting of the beneficial effects associated with wearing the hypoallergenic material of the present invention. Covering a greater proportion of the wearer's body increases the beneficial effects provided by the exercise garment. For example, leggings provide a greater effect relative to shorts.

In accordance with alternative implementations, the thermoplastic elastomer closed-cell foam material is cut to various patterned pieces, the pieces are joined together using a technique such as gluing or double gluing (glue is applied to both sides of each piece of material to be joined together), the joined and glued together pieces may optionally be nipped (a technique where pressure is applied to the joined seams), a piece of material such as heat welded tape made from a material such as stretch nylon is then placed on the inside of the seam and glued in place, the pieces are then blind stitched from one or both sides, and optionally the seams are covered with a material such as heat welded tape or the like. To complete the exercise garment 60, a zipper or zippers are optionally added along with logos, and the like. The steps heretofore described may be modified or adapted to various situations, materials, and exercise garment designs.

An exercise garment as described above, formed of a thermoplastic elastomer (TPE) foam material, can insulate a wearer as well or better than a neoprene-based exercise garment. Further, the exercise garment formed of the TPE foam material can withstand tearing, rough handling and severe conditions, yet is inherently flexible.

Although a few embodiments have been described in detail above, other modifications are possible. Other embodiments may be within the scope of the following claims.

1. An exercise garment comprising:
one or more sheets of closed-cell foam formed to cover one or more body parts of a wearer, the closed-cell foam being derived from polymerized thermoplastic resin pellets mixed with at least one foaming agent, the closed-cell foam being formed to a density of less than 0.22 grams per cubic centimeter, each of the one or more sheets of closed-cell foam having a thickness between about half a millimeter and about 2.5 millimeters and enabling movement of the one or more body parts of the wearer when covered by the one or more sheets of closed-cell foam.

2. The exercise garment in accordance with claim 1, further comprising an outer fabric attached to and covering at least a portion of an outer surface of at least one of the one or more sheets of closed-cell foam.

3. The exercise garment in accordance with claim 2, wherein the outer fabric includes woven nylon.

4. The exercise garment in accordance with claim 2, wherein the outer fabric includes aramid fiber.

5. The exercise garment in accordance with claim 2, wherein the outer fabric includes spandex.

6. The exercise garment in accordance with claim 2, wherein the outer fabric includes woven polypropylene.

7. The exercise garment in accordance with claim 1, further comprising an inner liner attached to and covering at least a portion of an inner surface of at least one of the one or more sheets of closed-cell foam.

8. The exercise garment in accordance with claim 7, wherein the inner liner includes spun nylon.

9. The exercise garment in accordance with claim 7, wherein the inner liner includes spandex.

10. A material comprising closed-cell foam derived from polymerized thermoplastic resin pellets mixed with at least one foaming agent, the closed-cell foam being formed to a density of less than 0.22 grams per cubic centimeter, each of the one or more sheets of closed-cell having a thickness between about half a millimeter and about 2.5 millimeters.

11. The material in accordance with claim 10, further comprising an outer fabric attached to and covering at least a portion of an outer surface of the closed-cell foam.

12. The material in accordance with claim 11, wherein the outer fabric includes woven nylon.

13. The material in accordance with claim 11, wherein the outer fabric includes aramid fiber.

14. The material in accordance with claim 11, wherein the outer fabric includes spandex.

15. The material in accordance with claim 11, wherein the outer fabric includes woven polypropylene.

16. The material in accordance with claim 10, further comprising an inner liner attached to and covering at least a portion of an inner surface of the closed-cell foam.

17. The material in accordance with claim 16, wherein the inner liner includes spun nylon.

18. The material in accordance with claim 16, wherein the inner liner includes spandex.

19. A method for manufacturing a exercise garment, the method comprising:
providing one or more sheets of closed-cell foam formed to cover one or more body parts of a wearer, the closed-cell foam being derived from polymerized thermoplastic resin pellets mixed with at least one foaming agent, the closed-cell foam being formed to a density of less than 0.22 grams per cubic centimeter, each of the one or more sheets of closed-cell foam having a thickness between about half a millimeter and about 2.5 millimeters and enabling movement of the one or more body parts of the wearer when covered by the one or more sheets of closed-cell foam; and
assembling the one or more sheets of closed-cell foam into a pattern defining at least a portion of the exercise garment.

20. The method in accordance with claim 19, wherein providing the one or more sheets of the closed-cell foam includes cutting the closed-cell foam into the one or more sheets to cover the one or more body parts of the wearer.
